(19) United States
(12) Patent Application Publication
(10) Pub. No.: US 2005/0246862 A1
(43) Pub. Date: Nov. 10, 2005

(54) Hinges and scanners utilizing the same

(75) Inventor: Yi-Sung Chen, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/084,243

(22) Filed: Mar. 21, 2005

(30) Foreign Application Priority Data
Apr. 16, 2004 (TW) 93205887

(51) Int. Cl. E05D 1/00

(52) U.S. Cl. 16/221

(57) ABSTRACT

Scanners and hinges thereof are provided. A hinge includes a first pivot portion, a second pivot portion, and a connecting portion. The first pivot portion is disposed on the cover. The second pivot portion is elastic, and is pivoted at the first pivot portion. The connecting portion is connected to the second pivot portion, and is disposed in the body. The cover rotates between a first angle and a second angle with respect to the connecting portion. When an angle intersected by the cover and the connecting portion exceeds a critical angle, the second pivot portion is separated from the first pivot portion by means of the elasticity of the second pivot portion.

### BACKGROUND

The invention relates to hinges, and in particular, to hinges for a scanner or an office machine.

In a conventional scanner or office machine, a hinge has only one operational mode, as disclosed in Taiwan Pub. No. 364711. When a cover of the scanner is pushed by an abnormal force, an angle intersected by the cover and the hinge may exceed a critical angle so that connecting portions between the hinge and the cover may be damaged.

### SUMMARY

A scanner is provided. An exemplary embodiment of a scanner comprises a cover, a hinge, and a body. The hinge comprises a first pivot portion, a second pivot portion, and a connecting portion. The first pivot portion is disposed on the cover. The second pivot portion is elastic and is disposed on the connecting portion to be pivoted at the first pivot portion. The cover rotates between a first angle and a second angle with respect to the connecting portion. When an angle intersected by the cover and the connecting portion exceeds a critical angle, the second pivot portion is separated from the first pivot portion by means of the elasticity of the second pivot portion. The body connects the connecting portion.

Note that the critical angle exceeds the second angle, and the connecting portion is detachably connected to the body.

Furthermore, the connecting portion comprises a pin, and the body comprises a hole. The hinge is connected to the body by inserting the pin into the hole. The depth of the connecting portion in the hole is adjustable based on an object to be scanned.

Moreover, the hinge further comprises an elastic support disposed around the second pivot portion. The first pivot portion comprises an abutment at an edge thereof. When the cover rotates to the second angle from the first angle, the abutment rotates and abuts the elastic support so that the elastic support deforms and snaps back by means of the elasticity of the elastic support. When the cover is located at the second angle, the elastic support supports the abutment by means of the elasticity thereof to prevent the cover from rotating.

Additionally, the hinge further comprises an elastic rib disposed around the second pivot portion to enhance strength of the second pivot portion.

A hinge is also provided. An exemplary embodiment of a hinge comprises a connecting portion, a first pivot portion, and a second pivot portion. The first pivot portion is disposed on the cover. The second pivot portion is disposed on the connecting portion and pivoted at the first pivot portion so that the cover rotates between a first angle and a second angle with respect to the connecting portion. The second pivot portion is elastic. When an angle intersected by the cover and the connecting portion exceeds a critical angle, the second pivot portion is separated from the first pivot portion by means of the elasticity of the second pivot portion.

### DESCRIPTION OF THE DRAWINGS

The invention can be more fully understood by reading the subsequent detailed description and examples with references made to the accompanying drawings, wherein:

FIG. 1 is a partial schematic view of an embodiment of a hinge;

FIG. 2a is a schematic view of an embodiment of a scanner, wherein a cover is closed;

FIG. 2b is another schematic view of the scanner in FIG. 2a, wherein the cover is open;

FIG. 3a is another schematic view of the scanner in FIG. 2a, wherein the cover is normally opened and an abutment is omitted; and

FIG. 3b is another schematic view of the scanner in FIG. 2a, wherein the cover is located at a critical angle.

### DETAILED DESCRIPTION

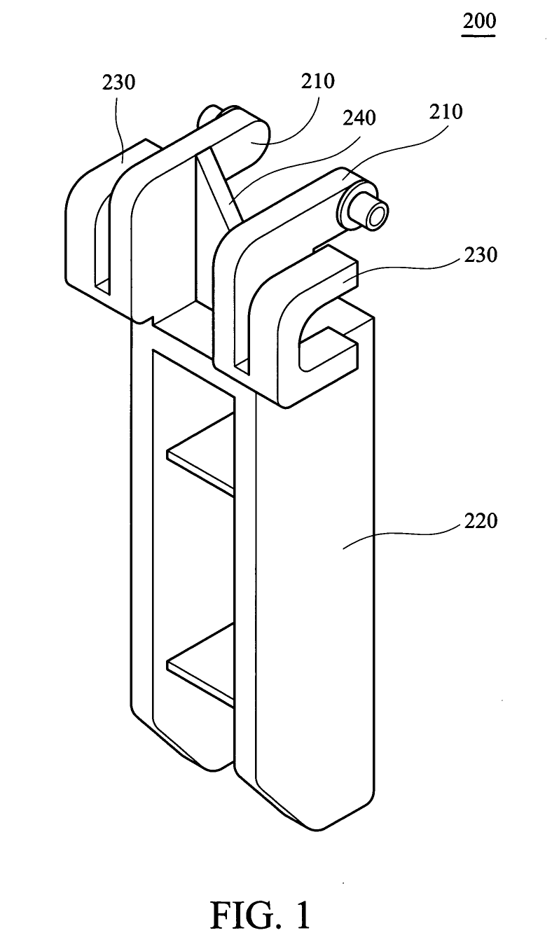

FIG. 1 is a partial schematic view of an embodiment of a hinge 200. The hinge 200 comprises two second pivot portions 210, a connecting portion 220, two elastic supports 230, and two elastic ribs 240. Note that only one elastic rib 240 is shown in FIG. 1. The connecting portion 220 is rectangular. Each elastic support 230 is disposed on the top of the connecting portion 220, and is C-shaped. Both elastic supports 230 are parallel. The second pivot portions 210 are also disposed on the top of the connecting portion 220, and are located between the elastic supports 230. One end of each second pivot portion 210 is formed with a cylindrical protrusion for pivoting. Note that the second pivot portions 210 are elastic. Each elastic rib 240 is a triangular plate, and is located between the second pivot portions 210 to enhance the strength of the second pivot portions 210.

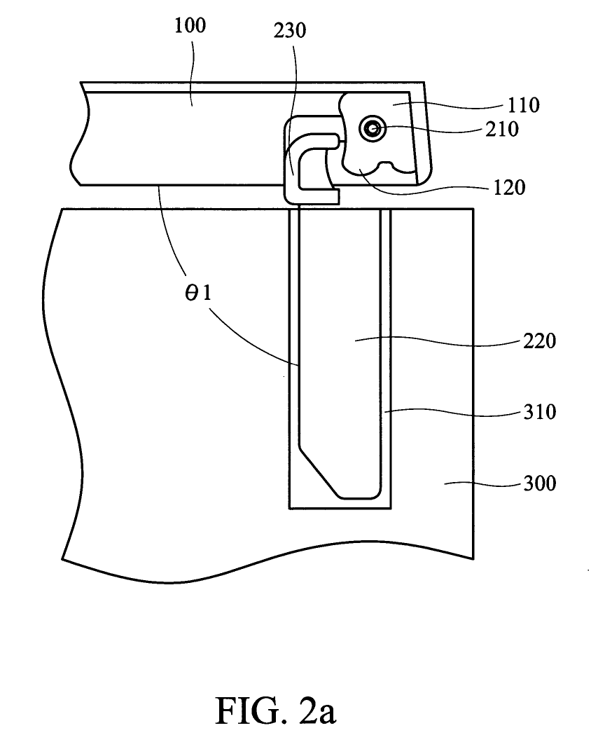

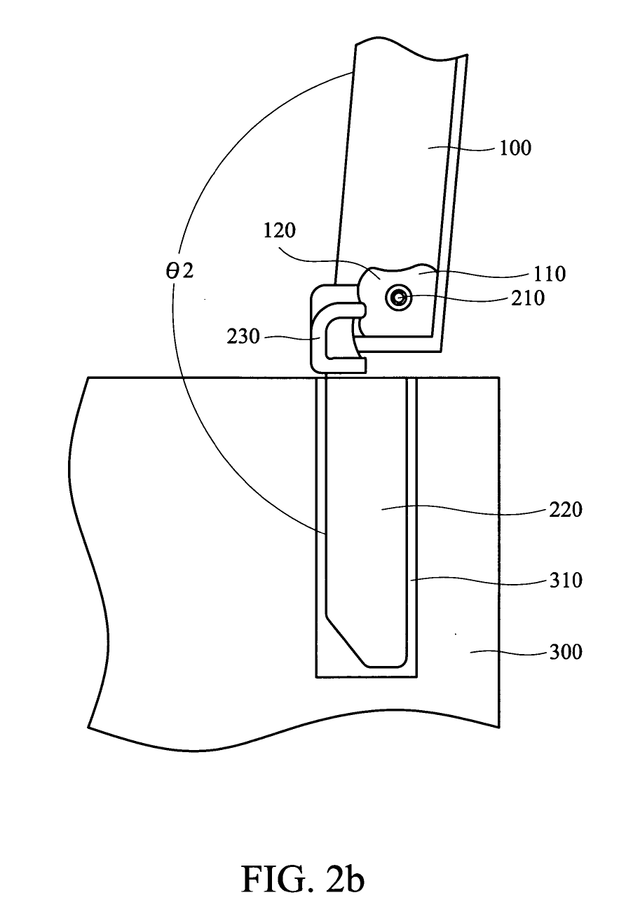

Referring to FIG. 2a, the hinge 200 further comprises two first pivot portions 110 and two abutments 120. Each abutment 120 is formed on the first pivot portion 110. The first pivot portions 110 are disposed on a cover 100 of a device, such as a scanner or an office machine. The cover 100 is rotatably connected to the second pivot portions 210 via the first pivot portions 110. Specifically, the second pivot portion 210 is pivoted at the first pivot portion 110. The connecting portion 220 is detachably inserted into a hole 310 in a body 300 of the device so that the hinge 200 is detachably connected to body 300. In FIG. 2a, the cover 100 is in a closed state, and an angle intersected by the cover 100 and the connecting portion 220 is a first angle θ1. At this time, the abutment 120 does not contact the elastic support 230.

When the cover 100 rotates to a second angle θ2 shown in FIG. 2b from the first angle θ1, the abutment 120 rotates and abuts the elastic support 230 so that the elastic support 230 deforms and snaps back by means of the elasticity of the elastic support 230.

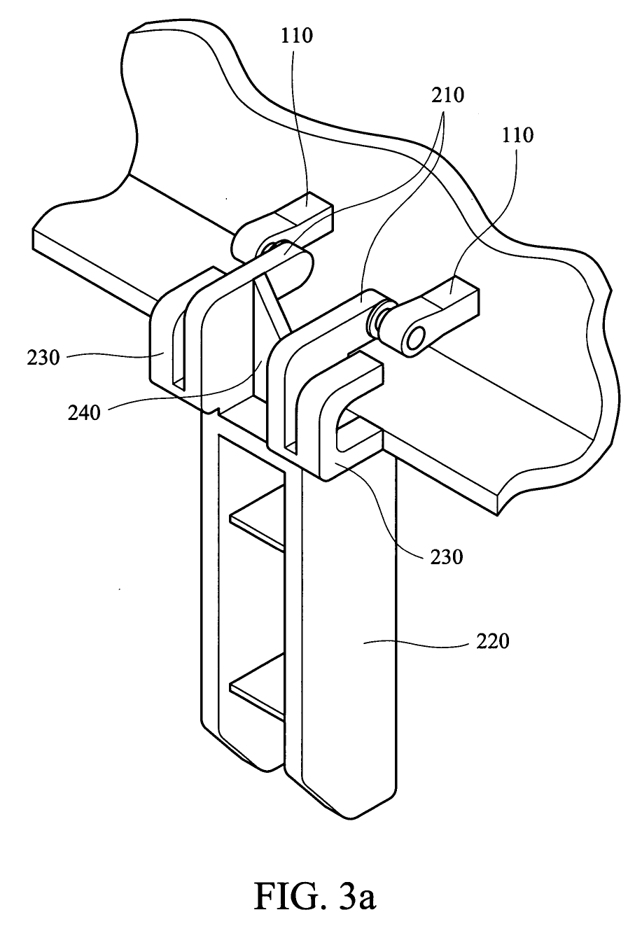

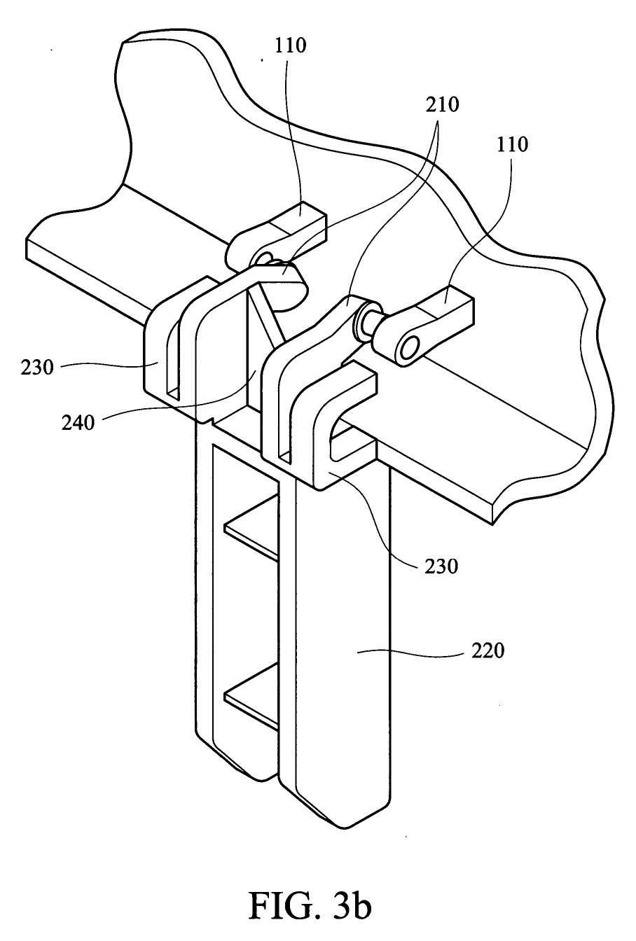

FIG. 3a is partially schematic view of the scanner when the cover 100 is located at the second angle θ2. At this time, the cover 100 is in an open state, and the elastic support 230 abuts the abutment 120 by means of the elasticity of the elastic support 230 so as to prevent the cover 100 from rotating abnormally.

When the angle intersected by the cover 100 and the connecting portion 220 exceeds the second angle θ2, the second pivot portion 210 deforms slightly by means of the elasticity thereof. At this time, the first pivot portion 110 is still connected to the second pivot portion 210 until the angle intersected by the cover 100 and the connecting portion 220 reaches a critical angle exceeding the second angle θ2. Referring to FIG. 3b, when the angle intersected by the cover 100 and the connecting portion 220 exceeds the critical angle, the second pivot portion 210 is separated from the first pivot portion 110 by means of the elasticity thereof. Thus, the first pivot portion 110 and the second pivot portion 210 can avoid damage or break when the cover 100 is opened abnormally.

The elastic rib 240 can enhance the strength of the second pivot portion 210 to prevent the second pivot portion 210 from damage when separating from the first pivot portion 110.

As previously described, the device, such as a scanner or an office machine, comprises a cover 100, a hinge 200, and a body 300. The hinge 200 connects the cover 100 and the body 300 by the first pivot portion 110 pivoting the second pivot portion 210.

The connecting portion 220 is a pin. The hinge 200 is connected to the body 300 by inserting the connecting portion 220 into the hole 310. The depth of the connecting portion 220 in the hole 310 is adjustable based on the thickness of the object to be processed, such as scanned object.

As previously described, when the cover is opened abnormally so that the angle intersected by the cover and the connecting portion exceeds the critical angle, the second pivot portion can be separated from the cover by means of the elasticity, thus potentially preventing breakage or damage of the hinge and the cover.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A scanner comprising:
a cover;
a hinge comprising a first pivot portion, a second pivot portion, and a connecting portion, wherein the first pivot portion is disposed on the cover, the second pivot portion is elastic and is disposed on the connecting portion to be pivoted at the first pivot portion, the cover rotates between a first angle and a second angle with respect to the connecting portion, and the second pivot portion is separated from the first pivot portion by means of the elasticity of the second pivot portion when an angle intersected by the cover and the connecting portion exceeds a critical angle; and
a body connecting the connecting portion.

2. The scanner as claimed in claim 1, wherein the critical angle exceeds the second angle.

3. The scanner as claimed in claim 1, wherein the connecting portion is detachably connected to the body.

4. The scanner as claimed in claim 1, wherein the connecting portion comprise a pin, the body comprises a hole, and the hinge is connected to the body by inserting the pin into the hole.

5. The scanner as claimed in claim 4, wherein the depth of the connecting portion in the hole is adjustable based on an object to be scanned.

6. The scanner as claimed in claim 1, wherein the hinge further comprises an elastic support disposed around the second pivot portion, the first pivot portion comprises an abutment at an edge thereof, the abutment rotates and abuts the elastic support so that the elastic support deforms and snaps back by means of the elasticity of the elastic support when the cover rotates to the second angle from the first angle, and the elastic support supports the abutment by means of the elasticity thereof to prevent the cover from rotating when the cover is located at the second angle.

7. The scanner as claimed in claim 1, wherein the hinge further comprises an elastic rib disposed around the second pivot portion to enhance strength of the second pivot portion.

8. A hinge, connecting a cover, comprising:
a connecting portion;
a first pivot portion disposed on the cover; and
a second pivot portion disposed on the connecting portion to be pivoted at the first pivot portion so that the cover rotates between a first angle and a second angle with respect to the connecting portion, wherein the second pivot portion is elastic to be separated from the first pivot portion by means of the elasticity of the second pivot portion when an angle intersected by the cover and the connecting portion exceeds a critical angle.

9. The hinge as claimed in claim 8, wherein the critical angle exceeds the second angle.

10. The hinge as claimed in claim 8, further comprising an elastic support disposed around the second pivot portion, wherein the first pivot portion comprises an abutment at an edge thereof, the abutment rotates and abuts the elastic support so that the elastic support deforms and snaps back by means of the elasticity of the elastic support when the cover rotates to the second angle from the first angle, and the elastic support supports the abutment by means of the elasticity thereof to prevent the cover from rotating when the cover is located at the second angle.

11. The hinge as claimed in claim 8, further comprising an elastic rib disposed around the second pivot portion to enhance strength of the second pivot portion.
